(19) United States
(12) Patent Application Publication
(10) Pub. No.: US 2016/0280520 A1
(43) Pub. Date: Sep. 29, 2016

(54) LIFT ASSEMBLY FOR HEAVY CONTAINERS AND METHOD THEREOF

(71) Applicant: AMERICAN STANDARD MANUFACTURING, INC., CENTRAL BRIDGE, NY (US)

(72) Inventor: C. DOMINIC VICKARY, COBLESKILL, NY (US)

(21) Appl. No.: 15/081,457

(22) Filed: Mar. 25, 2016

Related U.S. Application Data
(60) Provisional application No. 62/138,493, filed on Mar. 26, 2015.

(51) Int. Cl. B66F 3/35

(52) U.S. Cl. CPC B66F 3/35

(57) ABSTRACT

A lift device including an elevating assembly, the elevating assembly including an inner tower and an outer tower that is moveable with respect to the inner tower, wherein a movement of the outer tower is driven by a lifting device located within the inner tower, and a cradle assembly operably connected to the elevating assembly. Furthermore, an associated method is also provided.

### CROSS-REFERENCE TO RELATED APPLICATIONS

This application is a non-provisional of and claims priority to U.S. Provisional Application No. 62/138,493, filed Mar. 26, 2015, and entitled, “Lift Assembly for Heavy Containers and Method Thereof”

### FIELD OF TECHNOLOGY

The following relates to a lift assembly and more specifically to embodiments of a lift assembly for lifting, titling, and inverting heavy containers.

### BACKGROUND

Numerous industries utilize large containment vessels that store contents, such as cryogenic fluids, propane, butane, and other substances. These vessels, known as cylinders, can be very heavy. Due to the weight of the cylinders, a lifting device is typically used to lift, tilt, or invert the cylinders when performing maintenance tasks on the cylinder and evacuation of contents remaining in the tank. Existing lifting devices utilize a hydraulic jack operated by pumping a hand crank or a foot pedal to generate the lift of a tower assembly. However, operating the hydraulic jacks both requires physical labor from an operator while also placing the operator closer to the lifting device when the cylinder is being inverted, both of which can result in operator injury.

Thus, a need exists for an apparatus and method for a lift assembly for heavy containers that eliminates the need for an operator to operate a mechanical jack assembly to lift, tilt, or invert a heavy cylinder.

### SUMMARY

A first aspect relates generally to a lift device comprising a base assembly, an elevating assembly operably connected to the base assembly, the elevating assembly including an inner tower and an outer tower that is moveable with respect to the inner tower, wherein the movement of the outer tower is driven by a lifting device located within or proximate the inner tower, and a cradle assembly operably connected to the elevating assembly.

A second aspect relates generally to a lift device comprising: an elevating assembly, the elevating assembly including an inner tower and an outer tower that is moveable with respect to the inner tower, wherein a movement of the outer tower is driven by a lifting device located within the inner tower, and a cradle assembly operably connected to the elevating assembly.

A third aspect relates generally to a method comprising disposing a lifting device within an inner tower to generate lift of an outer tower, and actuating the lifting device remotely from the lifting device.

A fourth aspect relates generally to a method of lifting a heavy container.

A fifth aspect relates generally to device using an inflatable lifting means to lift a heavy container.

A sixth aspect relates generally to a lifting assembly comprising: a base assembly, the base assembly having a first beam, a second beam, and a cross beam, the first beam being separated from the second beam a distance to define a workspace for handling a cylinder, an elevating assembly, the elevating assembly including a fixed inner tower and an outer tower moveably attached to the fixed inner tower, the fixed inner tower including a cavity within the fixed inner tower, an inflatable lifting device disposed within the cavity of the fixed inner tower, and a cradle assembly operably connected to the elevating assembly, the cradle assembly having at least two arms for engaging the cylinder, wherein the inflatable lifting device is actuated to lift and lower the outer tower with respect to the fixed inner tower without user operation of a jack or jack assembly.

A seventh aspect relates generally to a method lifting and manipulating a gas cylinder comprising: disposing an inflatable lifting device within an inner tower, the inner tower having an outer tower moveably attached thereto, and operably attaching a cradle assembly to the outer tower, the cradle assembly configured to securably engage the gas cylinder, wherein the inflatable lifting device is actuated to lift and lower the outer tower with respect to the inner tower without user operation of a jack or jack assembly.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a front, perspective view of an embodiment of a lift device;

FIG. 2A depicts a front, perspective assembly view of an embodiment of a lift device;

FIG. 2B depicts a rear, perspective assembly view of an embodiment of a lift device;

FIG. 3 depicts a rear, perspective, partial assembly view of an embodiment of the lift device;

FIG. 4 depicts a detailed view of an embodiment of an elevating assembly;

FIG. 5 depicts a front, perspective view of an embodiment of an inner tower;

FIG. 6 depicts a detailed view of an embodiment of an elevating assembly;

FIG. 7 depicts a section view of an embodiment of the lift device;

FIG. 8 depicts a rear, perspective view of an embodiment of the lift device in a lowered position;

FIG. 9 depicts a rear, perspective view of an embodiment of the lift device in a raised position;

FIG. 10 depicts a rear view of an embodiment of the lift device is a lowered position;

FIG. 11 depicts a side view of an embodiment of the lift device in a lowered position;

FIG. 12 depicts a rear view of an embodiment of the lift device in a raised position;

FIG. 13 depicts a side view of an embodiment of the lift device in a raised position;

FIG. 14 depicts a rear view of an embodiment of the lift device in a lowered position with a cylinder in a normal orientation;

FIG. 15 depicts a rear view of an embodiment of the lift device in a raised position with a cylinder at a 90° orientation;

FIG. 16 depicts a rear view of an embodiment of the lift device in a raised position with a cylinder in an inverted position; and

FIG. 17 depicts a side view of an embodiment of the lift device in a raised portion with a cylinder in an inverted position.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

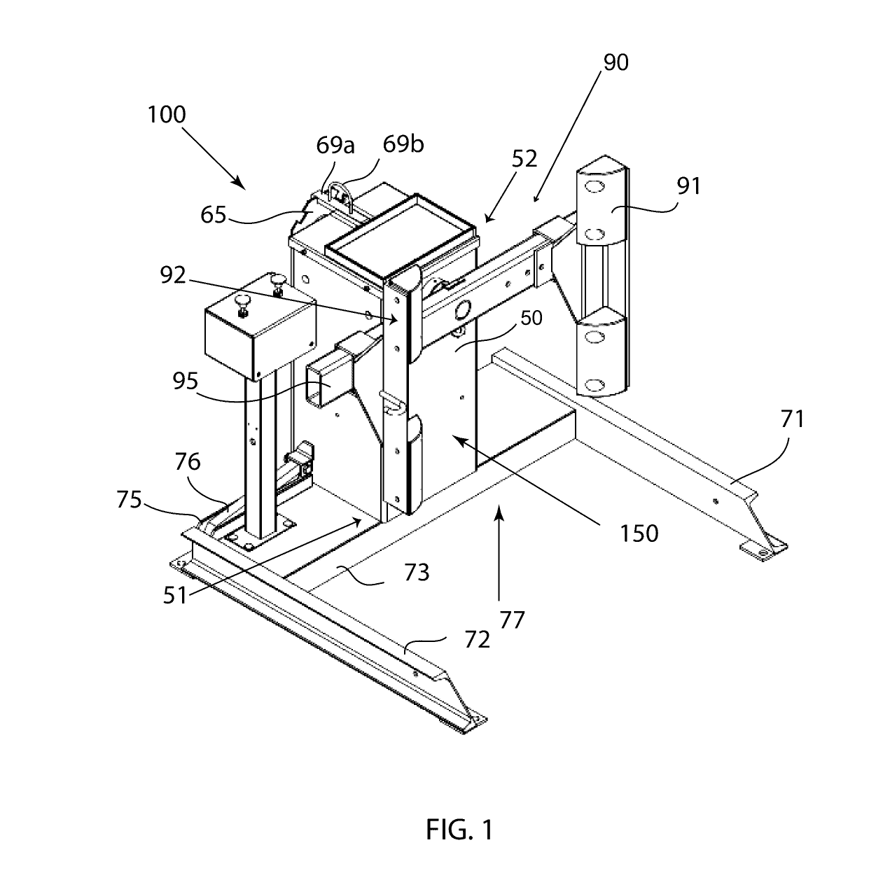

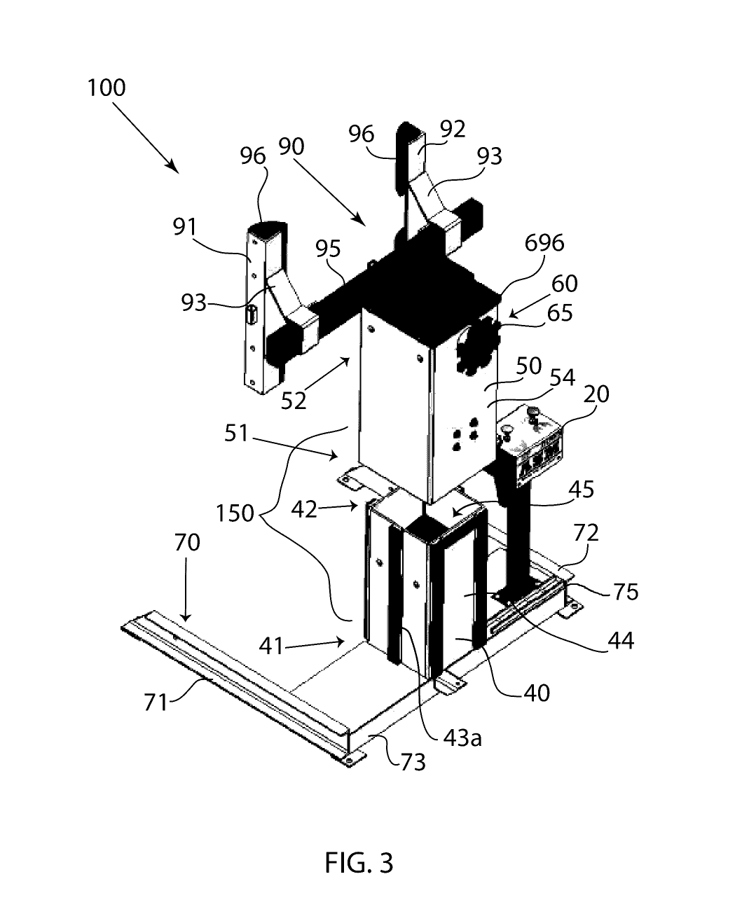

Referring to the drawings, FIGS. 1-3 depict embodiments of a lift device 100. Embodiments of the lift device 100 may be a lift assembly, a lift device, a lift, an inverter, a tank inverter, a cylinder lift, a cylinder inverter, a stationary cylinder inverter, a stationary tank inverter, a heavy container lift, a heavy container inverter, a stationary heavy container inverter, or any device that can lift a cylinder or heavy container and tilt or invert the cylinder or heavy container. Embodiments of cylinder 10 may be a cylinder, a tank, a gas storage container, a vessel, a container, a propane tank, a gas cylinder, a low-pressure gas cylinder, a high-pressure gas cylinder, a propane motor-fuel cylinder, and the like, which may contain fluids under pressure, in gas or liquid form, such as propane, cryogenic fluids, butane, and other volatile substances. Lift device 100 may be used to handle cylinders 10 of various weights and sizes, including positioning the cylinder 10 for evacuation of any remaining contents within the cylinder 10, or a variety of maintenance tasks, such as revalving and bottom maintenance. For example, embodiments of the lift device 100 may be used to lift, elevate, raise, etc. a cylinder 10, and then invert the cylinder 10 to safely and totally evacuate the contents of the cylinder 10. Embodiments of the cylinder 10 that can be manipulated by lift device 100 may have various shapes and sizes (i.e. not limited to a cylindrical shaped tank).

Embodiments of the lift device 100 may include a base assembly 70, an elevating assembly 150, and a cradle assembly 90. Embodiments of the lift device 100 may include a base assembly 70, an elevating assembly 150 operably connected to the base assembly 70, the elevating assembly 150 including an inner tower 40 and an outer tower 50 that is moveable with respect to the inner tower 40, wherein the movement of the outer tower 50 is driven by a lifting device 46 located proximate an upper portion of the inner tower 40, and a cradle assembly 90 operably connected to the elevating assembly.

Referring to FIGS. 1-3, embodiments of the lift device 100 may include a base assembly 70. The base assembly 70 may support the lift device 150, and may be positioned on a ground surface for use. Embodiments of the base assembly 70 may include a first beam 71, a second beam 72, and a cross beam 73. The top surface of the cross beam 73 may serve as a platform for mounting equipment and/or controls, such as a control panel 20. The cross beam 73 may also connect the first beam 71 and the second beam 72. For example, the first beam 71 may be connected to the cross beam 73 at one end of the cross beam 73, while the second beam 72 may be connected at the opposing end of the cross beam 73 to form the base assembly 70. Embodiments of the first beam 71 and the second beam 72 may be beams, length beams, feet, footings, members, and the like, and may have various cross-sections. Moreover, embodiments of the first beam 71 and the second beam 72 may be positioned perpendicularly or substantially perpendicular to the cross beam 73, wherein an opening or a space 77 is located between the beams 71, 72; the width of the space between the beams 71, 72 may generally be defined by the length of the cross beam 73. The space 77 may be large enough for the positioning of a cylinder 10 therebetween for operable attachment to the cradle assembly 90. Embodiments of the beams 71, 72, 73 may be secured to ground/floor via fasteners passing through openings in the beams 71, 72, 73. Additional beams or feet may be used or added to the base assembly 70 for stability or workability in a particular physical workspace. In other embodiments, the cross-beam 73 may a platform separate from the base assembly 70. In such an embodiment, beams, such as beams 71, 72 may be attached to the platform. In even further embodiments, a base assembly 70 may include only a platform, wherein the elevating assembly 150 and other components, such as control panel 20, may be positioned thereon.

Furthermore, embodiments of the base assembly 70 may include a safety mechanism comprising a locking bar 76 and a locking track 75. Embodiments of the safety mechanism may act as a mechanical lock or mechanical backup when the lift device 100 is in an elevated position. For instance, embodiments of the locking bar 76 may be moveably, hingedly, pivotally, etc. connected to an outer tower 50 of the elevating means 150. As the outer tower 50 rises, the locking bar 25 may hinge or otherwise move with the outer tower 50. As the outer tower 50 rises, the locking bar 76 may slide across locking lugs within the locking track 75, wherein the locking lugs of the locking track 75 may securely lock the outer tower 50 into position. Embodiments of the locking track 75 may be disposed onto the top surface of the cross beam/platform 73. The locking bar 76 may drop to several different angular positions during elevation of the outer tower 50. Additionally, a control panel 20 and a column of the control panel 20 may be mounted onto the base assembly 70 for controlling the lift device 100. However, the control panel 20 may be positioned at a location not on the cross beam 73 or platform.

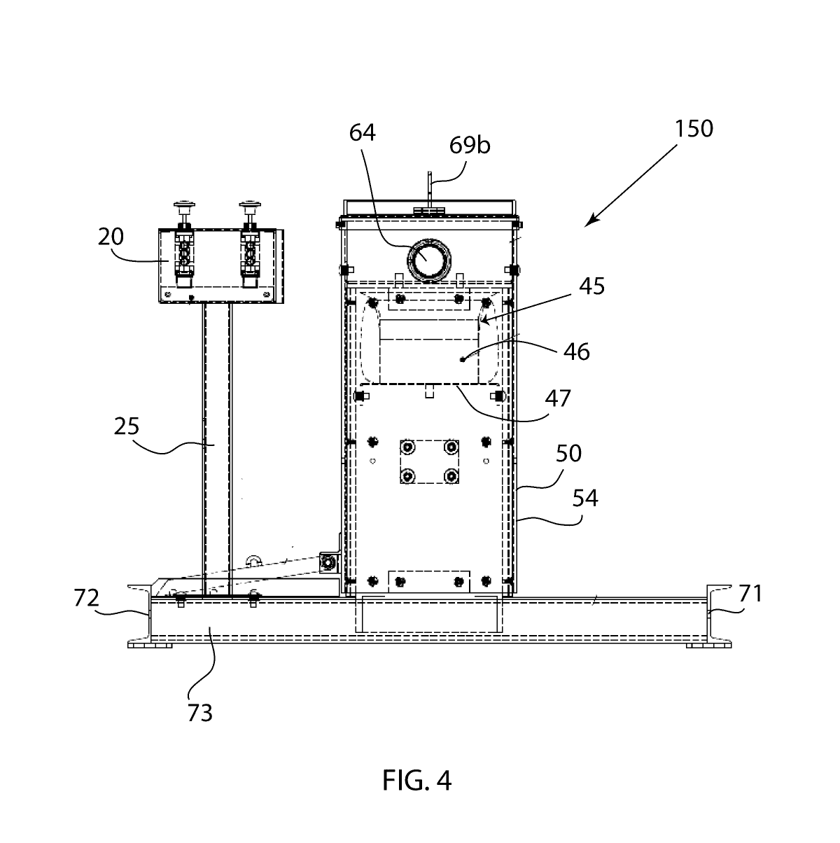

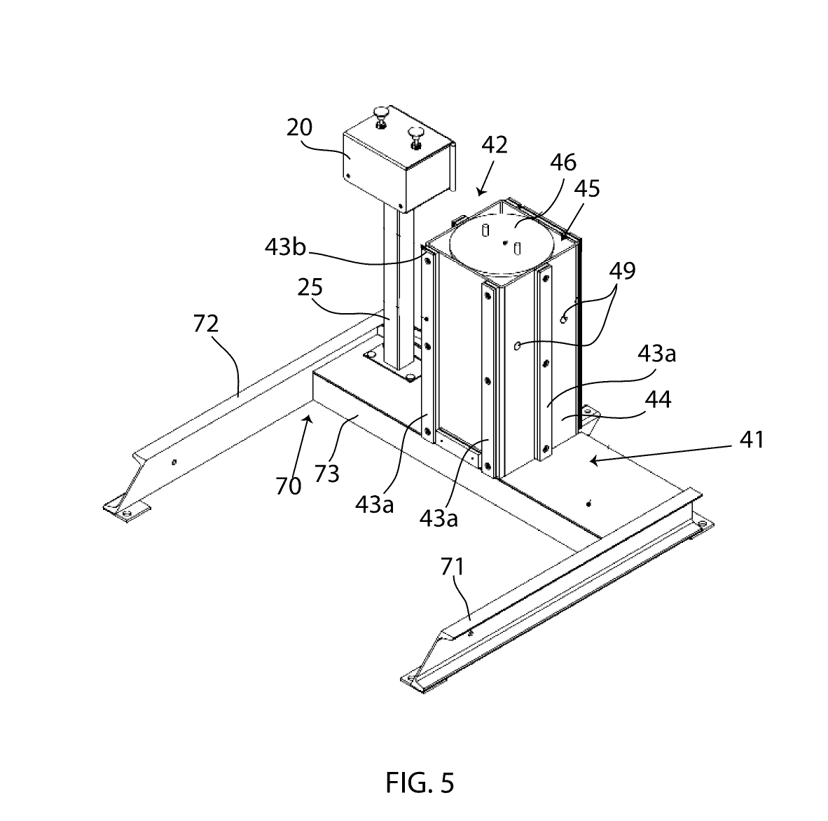

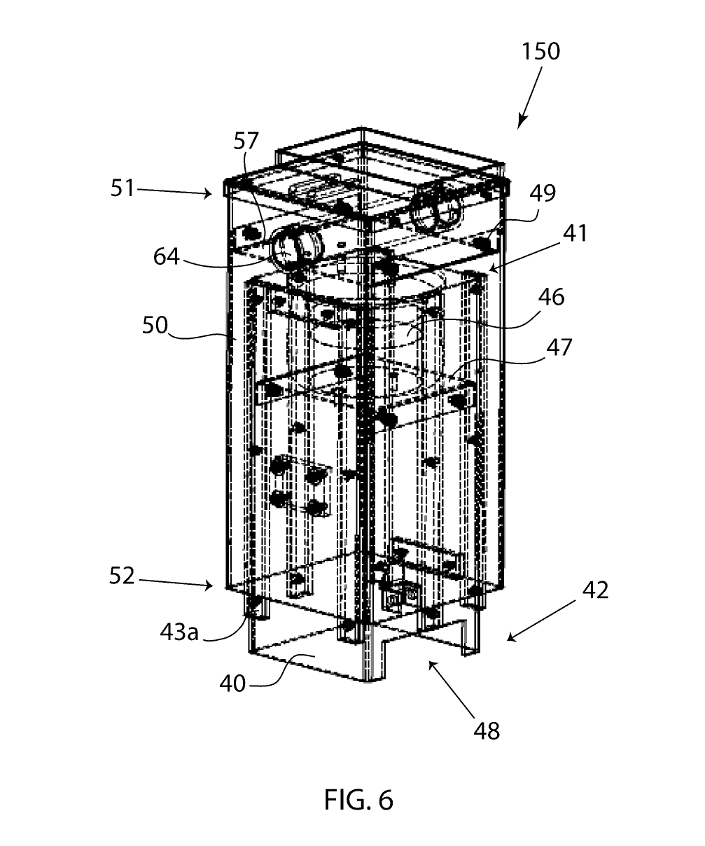

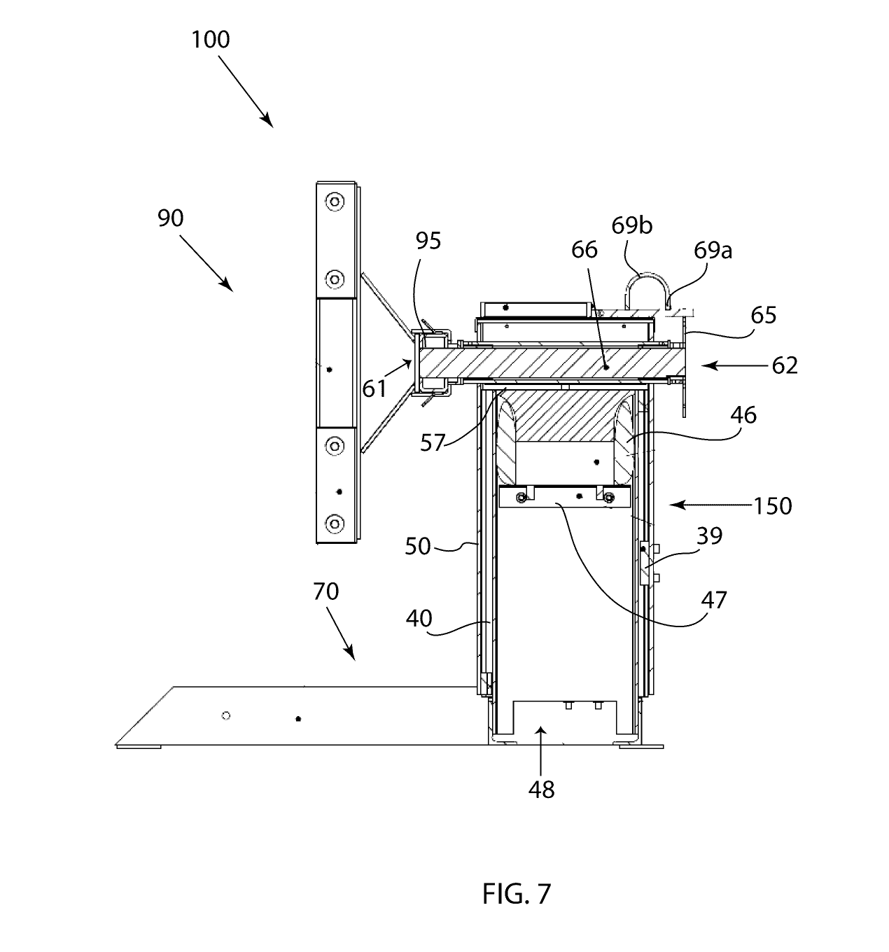

Referring still to FIGS. 1-3, and with additional reference to FIGS. 4-7, embodiments of the lift device 150 may include an elevating assembly 150. Elevating assembly 150 may be an elevating means, an elevator, a lift assembly, a lifting means, and the like. Embodiments of the elevating assembly 150 may be configured to lift, raise, elevate, or otherwise vertically manipulate a cylinder 10 and/or an outer tower 50. The elevating assembly 150 may be operably connected to the base assembly 70. Alternatively, the elevating assembly 150 may be secured to the ground via fasteners without connection to the base assembly 70, or received by a receiver/receiving mechanism that could secure the elevating means 150. Embodiments of the elevating assembly 150 may include an inner tower 40 and an outer tower 50. The outer tower 50 may be moveable with respect to the inner tower 40, as described in greater detail infra.

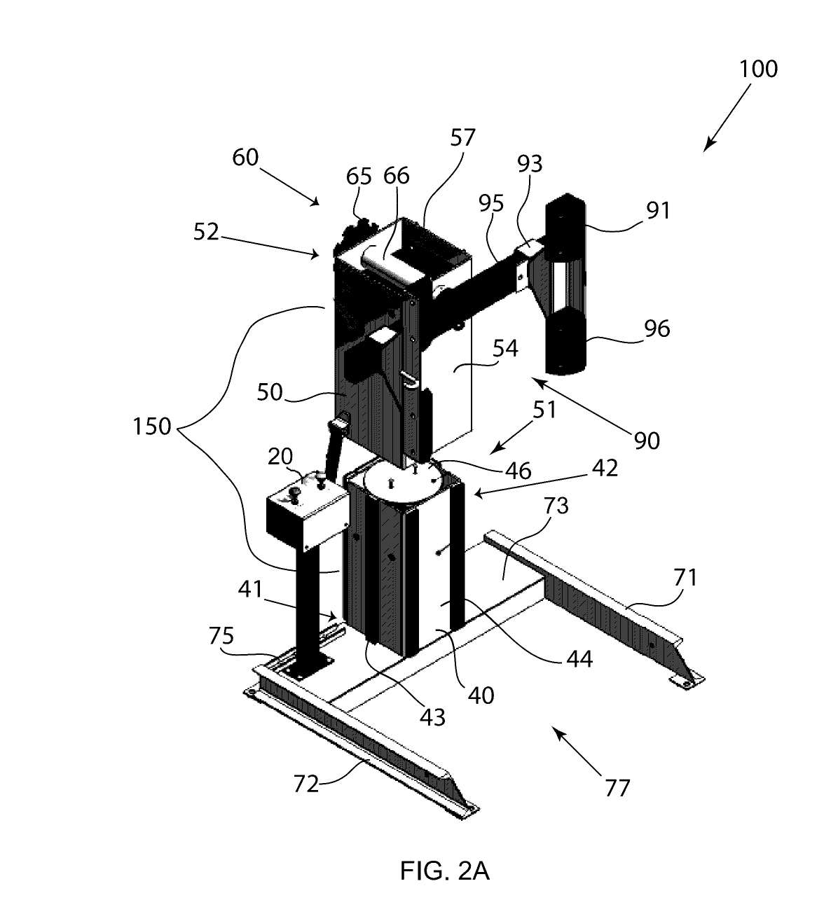

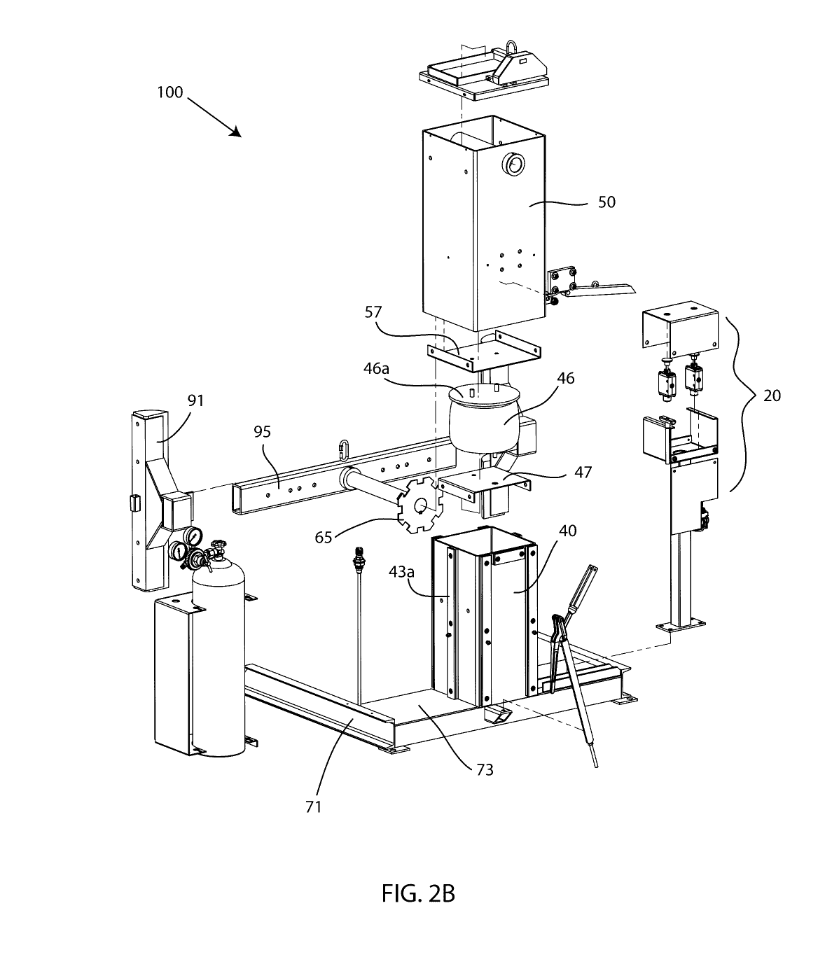

Embodiments of the inner tower 40 may include a first end 41, a second end 42, and an outer surface 44. Embodiments of the inner tower 40 may be a housing, a column, a stand, a shaft, and the like. The inner tower 40 may be securely fixed to the base assembly 70 or a ground surface, wherein the inner tower 40 is a fixed tower. Embodiments of the inner tower 40 may have a plurality of walls and a generally hollow interior. Alternatively, embodiments of the inner tower 40 may include one or more pathways or openings through the interior of the inner tower 40 while the remaining part of the inner tower 40 is a solid structure. Furthermore, a lifting device 46, such as an inflatable lifting device, an airbag, or even a hydraulic lifting means, may be positioned within the inner tower 40. The lifting device 46 may be disposed within an interior of the inner tower 40. The lifting device 46 may be positioned proximate the first end 41 of the inner tower 40, proximate a middle portion of the inner tower 40, or proximate a second end 42. For instance, a lifting device 46 may be disposed within a cavity 45 of the inner tower 40. Embodiments of the cavity 45 may be an opening, a receptacle, a recess, a space, or a location within the inner tower 40 that can accommodate and/or receive the lifting device 46. The cavity 45 may be located any vertical location within the inner tower 40 (e.g. proximate first end 41, second end 42, or middle portion). The sides of the cavity 45 or receptacle may be defined by the plurality of walls of the inner tower 40, while a bottom surface of the cavity 45 may be defined or formed by shelf 47, as shown in FIGS. 2B, 4, and 6. Shelf 47 may provide a shelf or surface that may support the lifting device 46 within the tower 40. Embodiments of the shelf 47 may be bolted to or otherwise fastened to at least one of the plurality of inner tower walls. In embodiments where the cavity 45 is proximate a top end, or second end 42, the top of the cavity 45 of the inner tower 40 may be open-end to allow for expansion/inflation of the lifting device 46. Placing the cavity 45 at a top portion of the inner tower 40 may be helpful with ease of production, but it can be located at various points within the inner tower 40.

Additionally, the lifting device 46 may be positioned outside of the inner tower 40. For example, the lifting device 46 may be positioned on a top end of the inner tower 40. In this position, the lifting device 46 may still be in a position to engage the outer tower 50 when inflated, without being disposed within the inner tower 40. A top surface of the inner tower 40 may act as shelf (similar to shelf 47), wherein a bottom surface of the inflatable lifting device 46 engages the top surface of the inner tower 40.

Referring still to FIGS. 4-7, embodiments of the elevating assembly 150 may include an outer tower 50 that is moveably attached or connected to the inner tower 40. Embodiments of the outer tower 50 may include a first end 51, a second end 52, and an outer surface 54. Embodiments of the outer tower 50 may have a plurality of walls and a generally hollow interior. Embodiments of the outer tower 50 may be a housing, a column, a shaft, a sleeve, and the like. The outer tower 50 may be configured to receive, accept, etc. the inner tower 40 within an interior of the outer tower 50. For example, the outer tower 50 may envelop the inner tower 40 when in an assembled configuration; the first end 51 may receive the second end 42 of the inner tower 40 when operably connecting the towers 40, 50 together. In other words, the outer tower 50 may be positioned over/around the inner tower 40. In addition, embodiments of the outer tower 50 may include an opening 64 proximate the second end 52 of the outer tower 50. Embodiments of the opening 64 may be a tubular opening, a bore, a channel, and the like, and may receive and/or allow the pass-through of a pivot shaft 66 operably connected to an index plate 65, which are part of the cradle assembly 90 described in great detail infra. Further positioned on a top surface of the outer tower 50 may be a tool tray, and an indexing lock 69a.

Furthermore, embodiments of the outer tower 50 may include an engagement surface 57 proximate the second end 52 of the outer tower 50. Embodiments of the engagement surface 57 may be a surface, a shelf, a partial shelf, a lip, and the like, positioned within the outer tower 50. The engagement surface 57 may be a horizontal or substantially horizontal edge or surface that may provide a portion of the outer tower 50 for the inflatable lifting device 46 to contact/engage to generate lift of the outer tower 50. For instance, upon actuation of the lift device 46, the lift device 46 may inflate or otherwise be raised causing the lift device 46 to mechanically physically engage the engagement surface 57 of the outer tower 50. In some embodiments, the lifting device 46, such as an inflatable lifting device, may include a plate 46a for engagement within the outer tower 50. The plate 46a may include one or more rods protruding therefrom, wherein the rods may pass through corresponding openings on the outer tower 50, or openings on the engagement surface 57. As the lift device 46 continues to inflate, or raise, the outer tower 50 may be raised due to the engagement between the inflatable lift device 46 and the engagement surface 57 of the outer tower 50. Conversely, the outer tower 50 may lower as the lift device 46 deflates or lowers. In embodiments where the lifting device 46 is not positioned proximate a top, open end of the inner tower 40, the lifting device 46 may engage a spacer, driver, or other component disposed within the inner tower 40 (e.g. above the lifting device 46) that can be driven towards the engagement surface 57 of the outer tower 50 to supply the lift of the outer tower 50. A spacer, driver, or other component disposed within the inner tower 40 (e.g. above the lifting device 46) that can be driven towards the engagement surface 57 of the outer tower 50 to supply the lift of the outer tower 50 may also be used when the lifting device 46 is positioned proximate a top end 41 of the inner tower 40.

Accordingly, the outer tower 50 is movable with respect to the inner tower 40 when the lifting device 46 is actuated. However, the movement therebetween may be facilitated, eased, guided, controlled, and/or otherwise controlled by a plurality of guide elements 43a located on the inner tower 40. Embodiments of the guide elements 43a may be located on the outer surface 44 of the inner tower 40, and may be positioned on each side of the inner tower 40. Conversely, embodiments of the guide elements 43a may be located on the outer surface 54 of the outer tower 50, and may be positioned on each side of the outer tower 50. In some embodiments, more than one guide element 43a may be located on a single side of the inner tower 40. Embodiments of the guide elements 43a may be a nylon strip or slide that may extend between the first end 41 and the second end 42 of the inner tower 40, or the ends 51, 52 of the outer tower 50. The nylon or similar material comprising the guide elements 43a may facilitate sliding between the components. Further embodiments of the guide elements 43a may be a plane bearing, and may be made of materials other than nylon. Moreover, the guide elements 43a may be attached to shims 43b that are directly connected to the outer surface 44 of the inner tower 40, or directly attached to the outer surface 54 of the outer tower 50. The guide elements 43a may be configured to contact/engage an inner surface of the outer tower 50 (or engage the outer surface 44 of the inner tower 40 if located on the outer tower 50), and when the outer tower 50 moves up and down with respect to the inner tower 40, contact between the inner surface of the outer tower 50 and the guide elements 43a may be maintained. The continued contact may prevent, reduce, or hinder side-to-side movement or tilting of the outer tower 50 with respect to the inner tower 40. Additionally, the guide elements 43a and the shims 43b may be modified to address clearance issues between the inner tower 40 and the outer tower 50. For instance, the thickness of the guide elements 43a or the combination of guide elements 43a and shims 43b may correspond to the gap between the inner surface of the outer tower 50 and the outer surface 44 of the inner tower 40.

When positioning the lifting device 46 within an interior of the inner tower 40 near a top end, or second end 42 of the inner tower 40, the lift of the elevating assembly 150 is coming from a top portion of the inner tower 40. For example, the lift being generated to raise the outer tower 50 (and ultimately the cylinder 10) may be located near an upper portion of the inner tower 40. Specifically, the lift is being generated via the lifting device 46 located in the cavity 45 proximate the top end 42 of the inner tower 40. Likewise, when positioning the lifting device 46 within an interior of the inner tower 40 near middle portion of tower 40 of the inner tower 40, the lift of the elevating assembly 150 is coming from a middle portion of the inner tower 40. Also, when positioning the lifting device 46 within an interior of the inner tower 40 near a bottom end, or first end 41 of the inner tower 40, the lift of the elevating assembly 150 is coming from a bottom portion of the inner tower 40. Moreover, a user can operate and/or actuate the lift device 46 remotely using a control panel 20 (and/or buttons associated therewith) that controls a flow or air or other fluid to the lift device 46 located proximate a top end of the inner tower 40. The air, fluid, or gas may be supplied by a fluid source, wherein the fluid source may include a regulator. A notch 48 may be formed proximate a first end 41, or a bottom end, of the inner tower to accommodate one or more air or other fluid lines passing through an interior of the inner tower 40 to the lifting device 46. However, one or more air lines may be fed external to the inner tower 40 (or outer tower 50) and then to the lift device 46. In some embodiments, it is possible that the lifting device 46 may be located external to the interior of the inner tower 40. For example, an lifting device 46 may be actuated to inflate or otherwise raise and engage an arm or other structural member that extends from the outer tower 50 (e.g. perpendicularly) to raise the outer tower 50. In this type of embodiment, a driver, spacer, or other component may be used to engage the arm or other structural member.

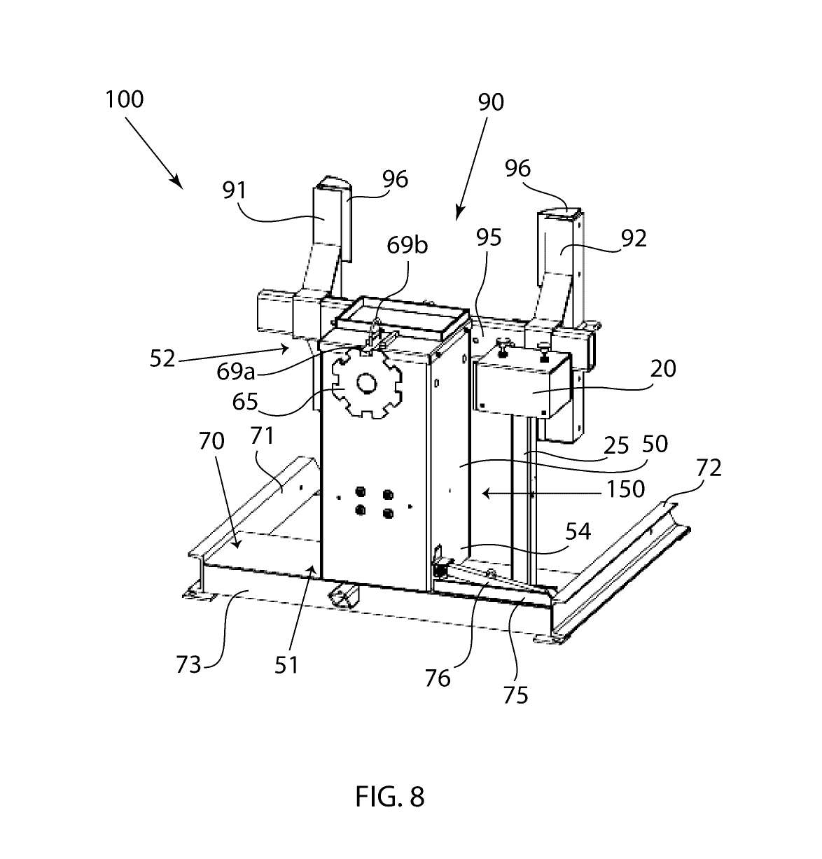

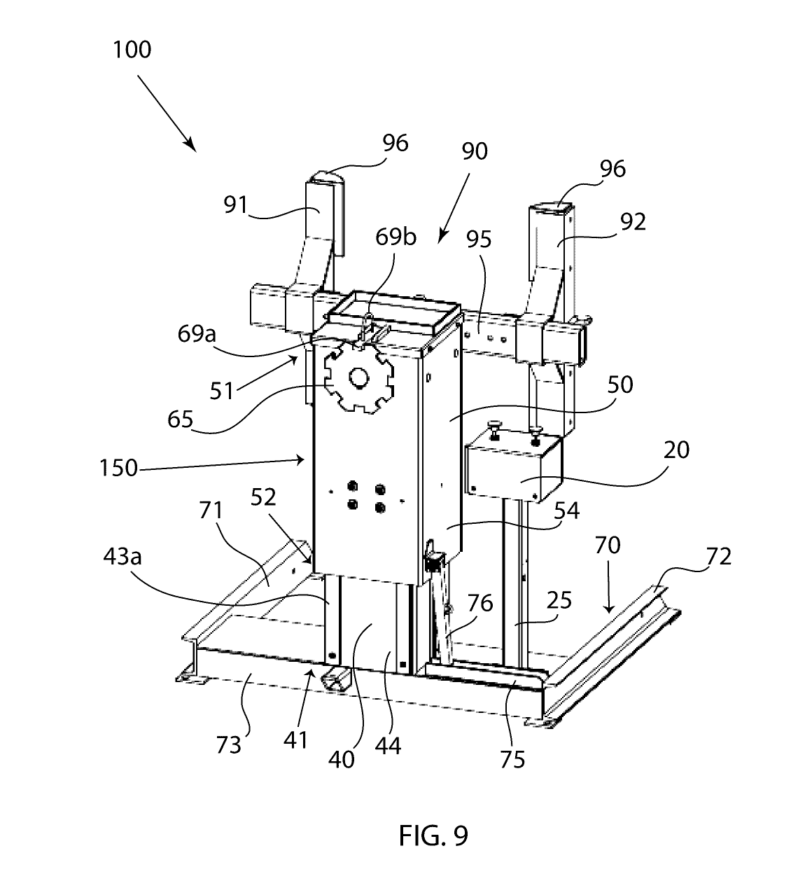

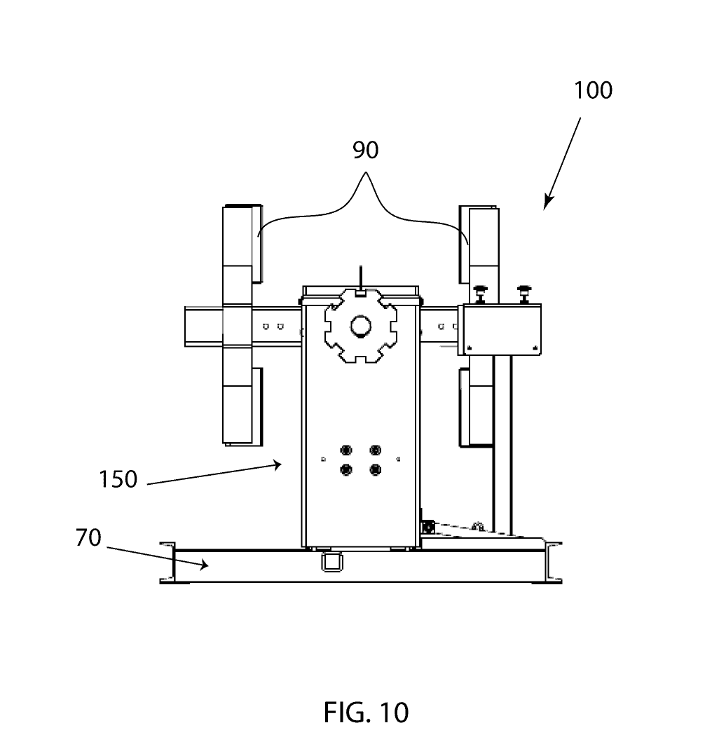

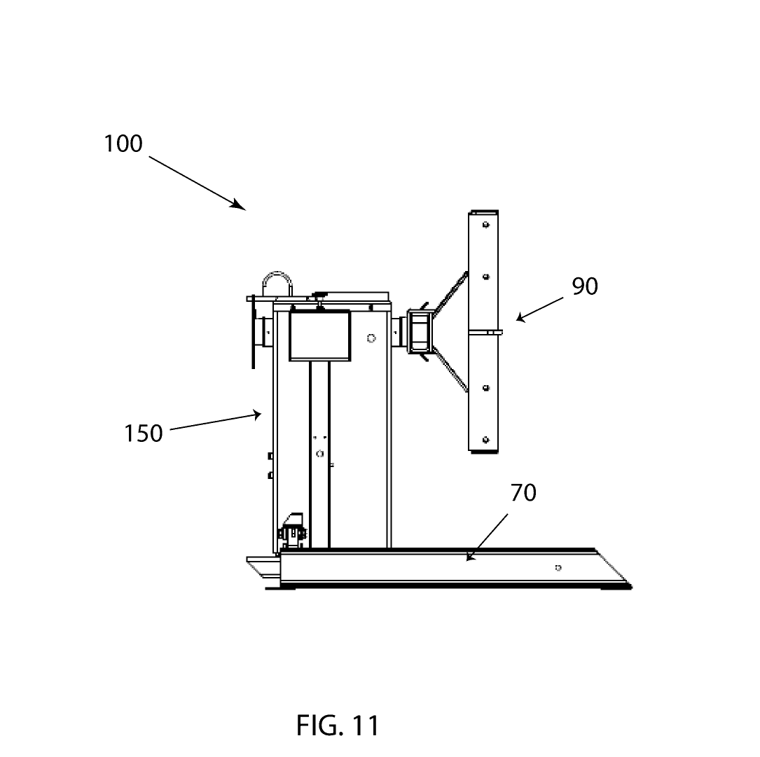

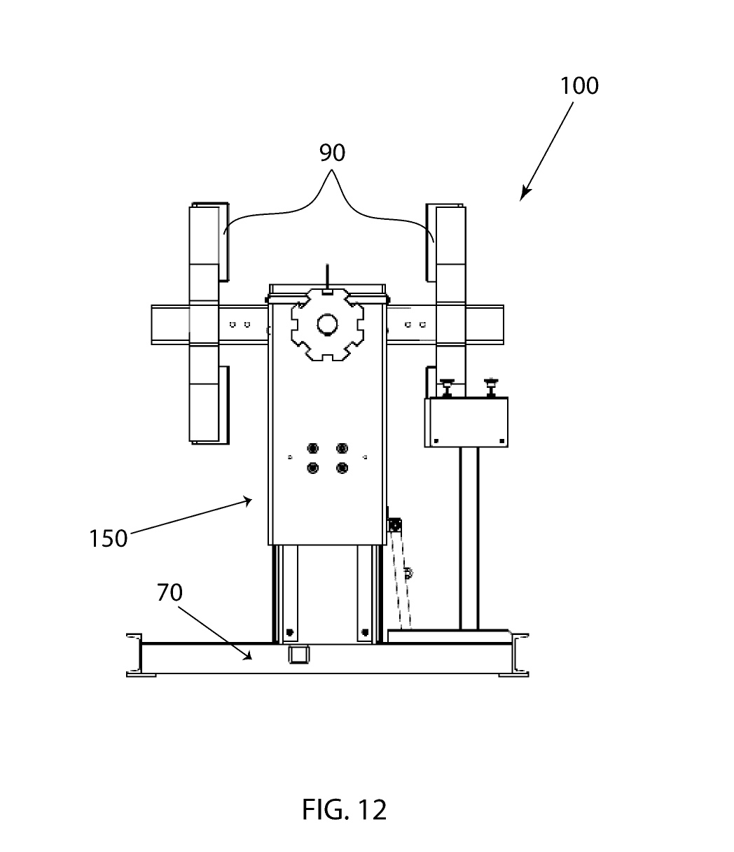

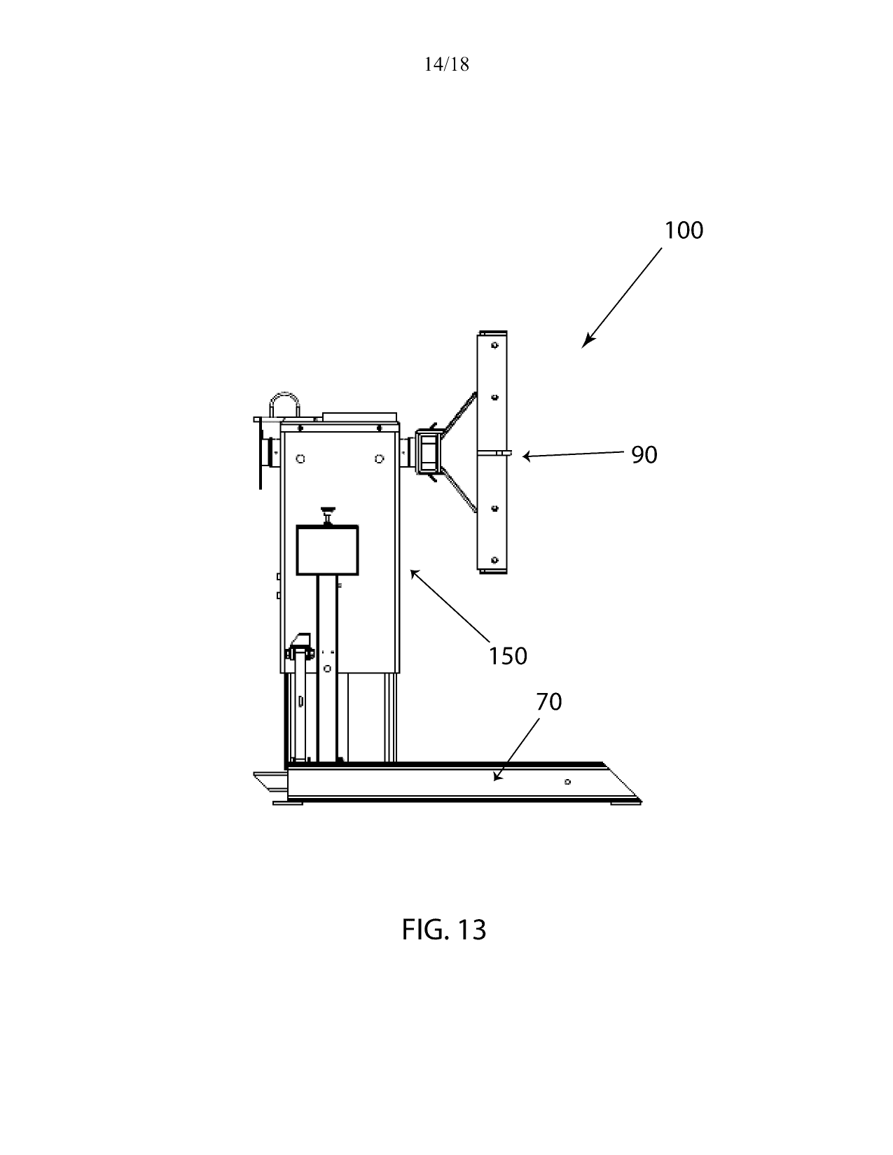

With reference to FIGS. 8-13, embodiments of the lift device 100 are shown in a lowered position and a raised position. Through actuation of the elevating assembly 150, the lift device 100 may achieve a lowered position, as shown in FIGS. 8, 10, and 11, and a raised position, as shown in FIGS. 9, 12, and 13. Through operation of one or more control panels, such as panel 20, the elevating assembly 150 may be actuated to lift and lower the outer tower 50 with respect to the inner tower 40 without user operation of a jack or jack assembly.

Referring back to FIGS. 1-3 and 7, embodiments of the lift device 100 may also include a cradle assembly 90. Embodiments of cradle assembly 90 may be operably connected to the elevating assembly 150, which may be operably connected to the base assembly 70. While the elevating assembly 150 moves vertically (or when the elevating assembly is stationary), the cradle assembly 90 may rotate at various vertical points because of the shaft 66 positioned through the outer tower 50 of the elevating assembly 150. Embodiments of the shaft 66 may include a first end 61 and a second end 62, wherein each end 61, 62 of the shaft 66 may be exposed. Embodiments of the shaft 66 may be connected to a rotational and indexing mechanism 65, or index plate, at the second end 62 of the shaft 66. Embodiments of the index mechanism or index plate 65 may include a plurality of notches corresponding to various angles (e.g. 0°, 45°, 90°, and 180°) at which the cylinder 10 is tilted when the cradle assembly 90 is rotated. The other end of the shaft 66, the first end 61, may be operably connected to a cradle beam 95. The cradle beam 95 may be perpendicularly mounted to the shaft 32. Embodiments of the indexing mechanism 65 and the cradle beam 95 may be rotatable about a central shaft axis in a coplanar relationship. Embodiments of the cradle assembly 90 may further include at least a first arm 91 and a second arm 92. Embodiments of the first 91 and the second arm 91 may be operably connected to the cradle beam 95. Embodiments of the first arm 91 and second arm 92 may be opposing arms, jaws, or otherwise opposing, elongate units. Each of the arms 91, 92 may include contact pads, such as contact pad 96, for reducing damage or harm to the cylinders 10 or the contents therein. The distance between the arms 91, 92 may be adjustable by slidably moving the arms 91, 92 along the cradle beam 95. The arms 91, 92 may be configured to engage with a cylinder 10 by positioning a cylinder 10 therebetween. A ratchet strap or other securing means may be wrapped around the cylinder 10 and secured to the arms 91, 92 when lifting and/or inverting the cylinder 10.

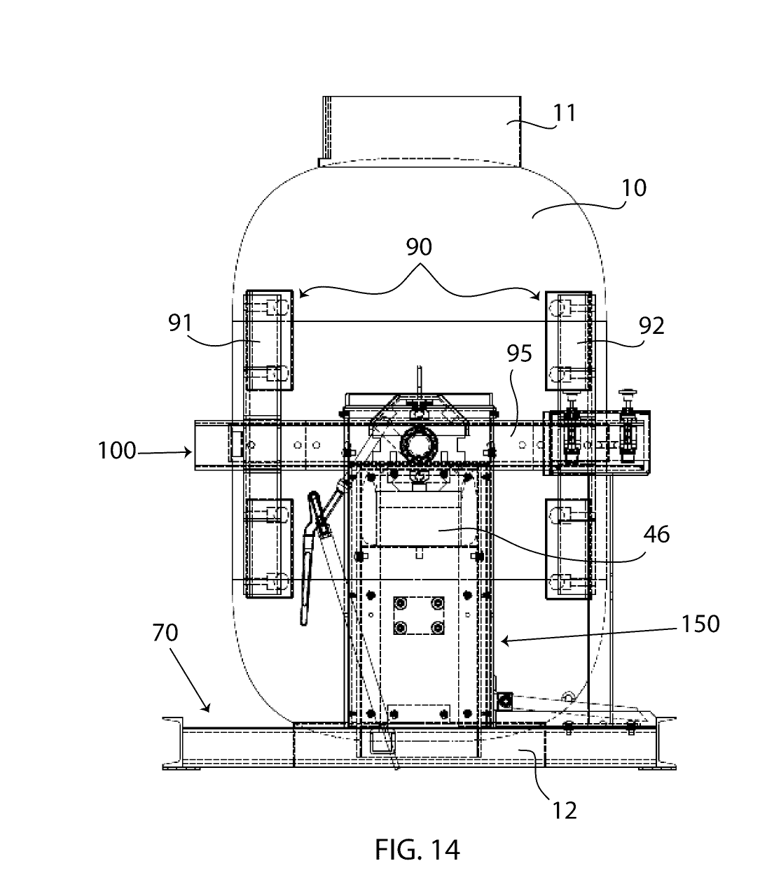

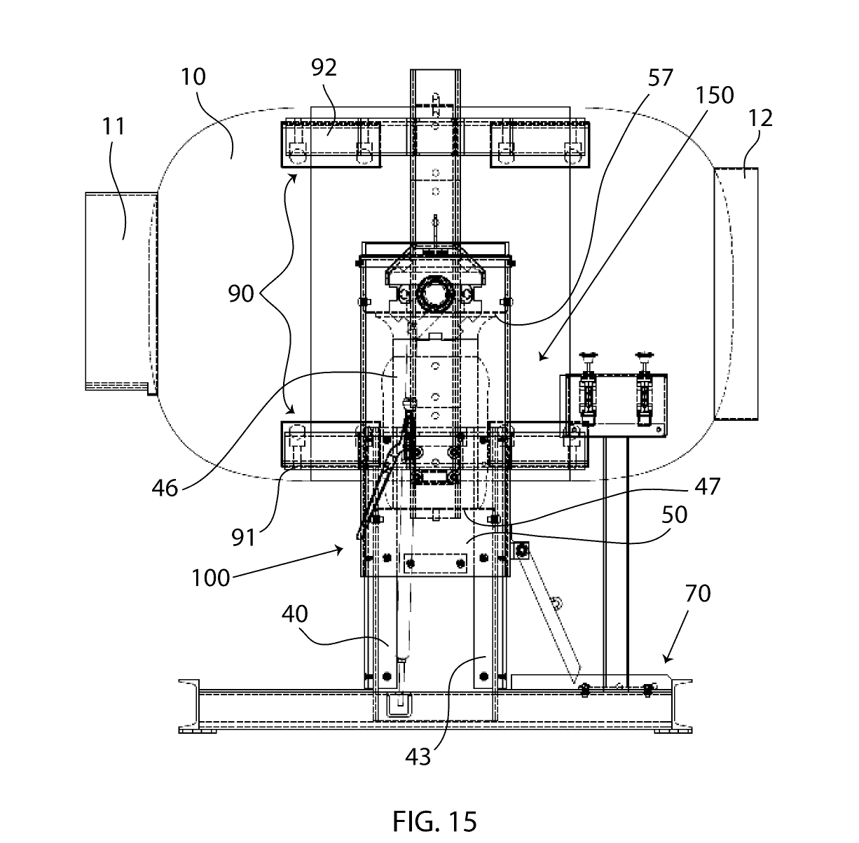

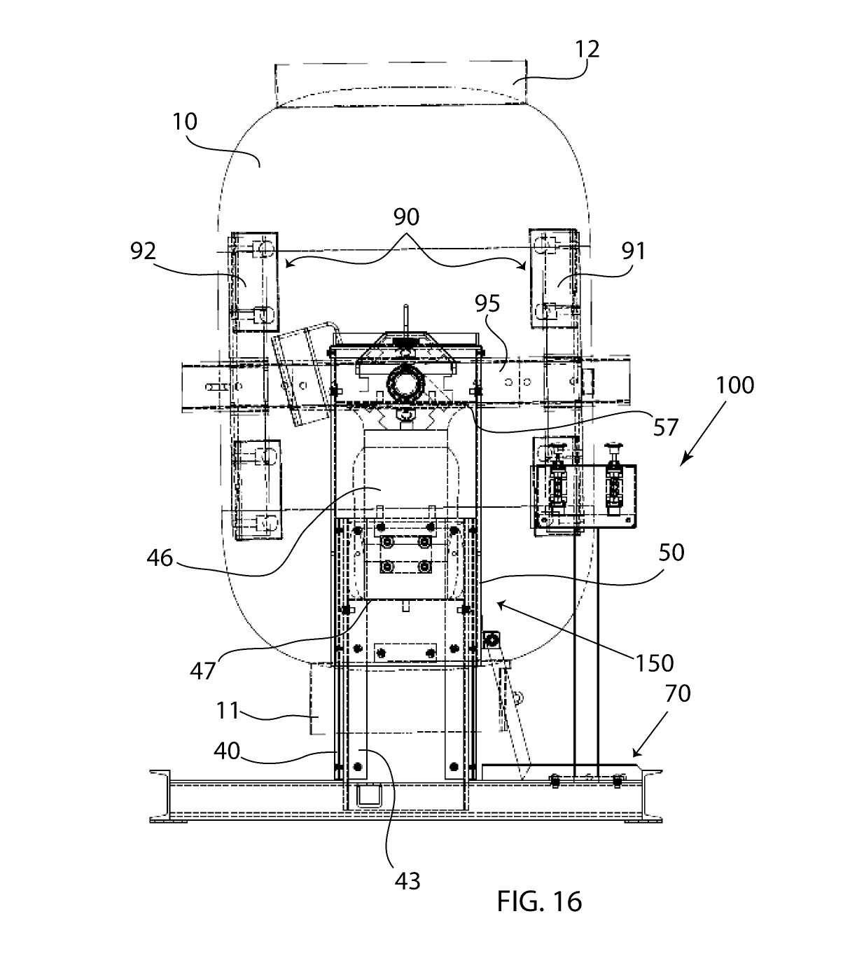

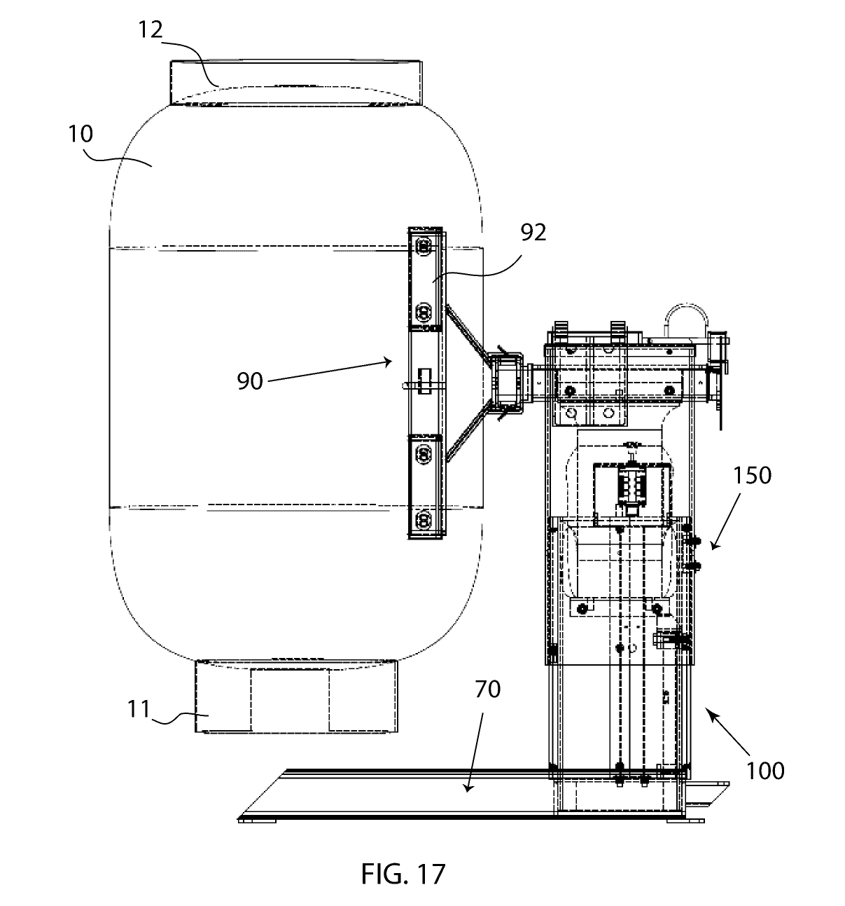

Referring now to FIGS. 14-17, embodiments of the lift device 100 is shown during operation with a cylinder 10. FIG. 14 depicts an embodiment of the lift device 100 in a lowered position, wherein a cylinder 10 has been gripped and/or engaged by the cradle assembly 90 (ratchet strap not shown); the top 11 of the cylinder 10 is positioned above the bottom 12 in this position. FIG. 15 depicts an embodiment of the lift device 100 in a raised position, wherein the cylinder 10 has been rotated 90° by the cradle assembly 90. FIGS. 16 and 17 depict an embodiment of the lift device 100 in a raised position, wherein the cylinder 10 has been inverted, and the bottom 12 of the cylinder 10 is positioned above the top end 11.

With reference to FIGS. 1-17, embodiments of a method of lifting a cylinder 10 may include the steps of providing lift device 100 including a base assembly 70, an elevating assembly 150 operably connected to the base assembly 70, the elevating assembly 150 including an inner tower 40 and an outer tower 50 that is moveable with respect to the inner tower 40, wherein the movement of the outer tower 50 is driven by a lifting device 46 disposed within the inner tower 40, and a cradle assembly 90 operably connected to the elevating assembly 150. Further embodiments of a method may include disposing a lifting device 46 within an inner tower 40 to generate lift of an outer tower 50, and actuating the lifting device 46 remotely from the lifting device 46. A further embodiment of a method lifting and manipulating a gas cylinder 10 may include the steps of disposing an inflatable lifting device 46 within an inner tower 40, the inner tower 40 having an outer tower 50 moveably attached thereto, and operably attaching a cradle assembly 90 to the outer tower 50, the cradle assembly 90 configured to securably engage the gas cylinder 10, wherein the inflatable lifting device 46 is actuated to lift and lower the outer tower 50 with respect to the inner tower 40 without user operation of a jack or jack assembly.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A lift device comprising:
an elevating assembly, the elevating assembly including an inner tower and an outer tower that is moveable with respect to the inner tower, wherein a movement of the outer tower is driven by a lifting device located within the inner tower; and
a cradle assembly operably connected to the elevating assembly.

2. The lift device of claim 1, wherein the lifting device is inflatable.

3. The lift device of claim 1, further comprising a base assembly.

4. The lift device of claim 2, wherein the lifting device is an airbag.

5. The lift device of claim 1, wherein the elevating assembly is activated remotely.

6. The lift device of claim 1, wherein the elevating assembly is actuated via a control panel.

7. The lift device of claim 1, wherein the cradle assembly engages a heavy container for inverting the heavy container.

8. The lift device of claim 1, wherein the movement of the outer tower with respect to the inner tower is facilitated by nylon strips therebetween.

9. The lift device of claim 1, wherein the lifting device is located proximate a top portion of the inner tower.

10. A lifting assembly comprising:
a base assembly, the base assembly having a first beam, a second beam, and a cross beam, the first beam being separated from the second beam a distance to define a workspace for handling a cylinder;
an elevating assembly, the elevating assembly including a fixed inner tower and an outer tower moveably attached to the fixed inner tower, the fixed inner tower including a cavity within the fixed inner tower;
an inflatable lifting device disposed within the cavity of the fixed inner tower; and
a cradle assembly operably connected to the elevating assembly, the cradle assembly having at least two arms for engaging the cylinder;
wherein the inflatable lifting device is actuated to lift and lower the outer tower with respect to the fixed inner tower without user operation of a jack or jack assembly.

11. The lifting assembly of claim 10, wherein, when the outer tower is raised, the cylinder engaged with the cradle assembly is also lifted above a ground surface.

12. The lifting assembly of claim 10, wherein the fixed inner tower includes a plurality of guide elements on an outer surface to facilitate movement between the outer tower and the fixed inner tower.

13. The lifting assembly of claim 10, wherein the plurality of guide elements are nylon strips.

14. The lifting assembly of claim 10, wherein the inflatable lifting device is actuated by user operation of a control panel located remotely from the lifting assembly.

15. The lifting assembly of claim 14, wherein the control panel controls a flow of air to the inflatable lifting device, the control panel being mounted to the base assembly.

16. A method lifting and manipulating a heavy container comprising:
disposing a lifting device within an inner tower, the inner tower having an outer tower moveably attached thereto; and
operably attaching a cradle assembly to the outer tower, the cradle assembly configured to securably engage the heavy container;
wherein the inflatable lifting device is actuated to lift and lower the outer tower with respect to the inner tower without user operation of a jack or jack assembly.

17. The method of claim 16, further comprising disposing a plurality of guide elements on an outer surface of the inner tower to facilitate movement between the outer tower and the inner tower.

18. The method of claim 16, wherein the plurality of guide elements are nylon strips.

19. The method of claim 16, further comprising: operably attaching the inner tower to a base assembly.

20. The method of claim 16, further comprising: controlling a flow of fluid to the inflatable lifting device via a control panel.
